(19) United States
(12) Patent Application Publication
(10) Pub. No.: US 2009/0205307 A1
(43) Pub. Date: Aug. 20, 2009

(54) LONG STRAND FORAGE HARVESTER

(76) Inventors: Jeffrey R. Warren, III, Penn Yan, NY (US); John E. Davie, Geneva, NY (US); Michael A. Kunes, Shortsville, NY (US)

Correspondence Address: HISCOCK & BARCLAY, LLP, 2000 HSBC PLAZA, 100 Chestnut Street, ROCHESTER, NY, 14604-2404, US

(21) Appl. No.: 12/031,529

(22) Filed: Feb. 14, 2008

(51) Int. Cl. A01D 43/06; A01D 57/20

(52) U.S. Cl. 56/153

(57) ABSTRACT

A device and method for cutting forage and lading the fresh cut forage onto a conveyor belt. The conveyer belt transports the fresh cut forage into a vehicle to transport the forage. The forage goes directly into the transport vehicle without being placed on the ground eliminating the need for additional runs to recover the forage.

### FIELD OF THE INVENTION

This invention relates to the cutting and loading of forage for transport, and more particularly to cutting of freshly grown long strand forage and immediately loading the cut forage into a transport vehicle.

### BACKGROUND OF THE INVENTION

It is known in the art of harvesting farm produce that forage, such as hay, grass and alfalfa, have a high moisture content and must be dried before storage to effectively preserve the forage. Dried forage is easier to handle, and has a longer storage life than moist forage. Moist forage easily molds thereby destroying the forage.

The traditional method for processing forage is to cut the forage when it has reached the bud stage or in early blossom. The forage is then allowed to dry in the sun as a loose mass in the field. The forage is then raked into windrows and turned so that the sun can dry the remaining material that remained on the ground. If the forage is not sufficiently dry it must also be teddered, or spread out on the ground again and allowed to dry further. The forage is then raked and windrowed again. Later the forage is baled either into square or large round bales. This process can take up to five days to complete, and may be compromised due to environmental effects such as rain. The long drying period causes the forage to lose some of its nutrients. This method also requires many passes of equipments throughout the process. This is inefficient as many steps are involved, the sun drying is a slow process, and weather is unpredictable.

By transporting freshly cut forage to a drying facility the required drying time is significantly reduced and more of the nutrients can be retained within the forage. However, in general there a lacks an efficient system for transporting moist fresh cut forage without first baling the forage.

It is therefore desired to cut and load forage for transportation without the need for sun drying or baling.

### SUMMARY OF THE INVENTION

The invention comprises, in one form thereof, a device for cutting forage and dropping the fresh cut forage onto a discharge system such as conveyor belt. The discharge system transports the fresh cut forage into a vehicle for transport. The forage goes directly into the transport vehicle without being placed on the ground or baling, eliminating the need for additional runs to recover the forage.

In another form, the invention includes a method for cutting and loading forage into a transport vehicle. The method comprises the steps of cutting forage, transporting the fresh cut forage to a discharge system and throwing the fresh cut forage to a transport vehicle.

An advantage of the present invention is that the forage is cut and loaded for transport in a single process by a single device.

A further advantage of the present invention is that the forage is quickly loaded for transport during harvesting, thereby reducing any negative environmental effects.

An even her advantage of the present invention is that the fresh cut forage is removed from the field allowing for immediate use of the field after harvesting.

### BRIEF DESCRIPTION OF THE DRAWINGS

The present invention is disclosed with reference to the accompanying drawings, wherein:

FIG. 1 is a rear schematic view of the harvester and a transport vehicle according to an embodiment of the present invention;

FIG. 2 is a side schematic view of the harvester and a transport vehicle according to an embodiment of the present invention with the vehicle portion of the harvester shown in phantom lines;

FIGS. 3A-3C are schematic view of the collector section of the harvester according to one embodiment;

FIG. 4 is schematic view of the planar discharge section of the harvester according to one embodiment;

FIGS. 5A-5B are schematic view of the substantially vertical discharge section of the harvester according to one embodiment;

Corresponding reference characters indicate corresponding parts throughout the several views. The example set out herein illustrate embodiments of the invention but should not be construed as limiting the scope of the invention in any manner.

### DETAILED DESCRIPTION

Freshly grown forage includes long strand forage such as hay, grass, alfalfa or switchgrass. Long strand forage is defined as forage having a height between about 6 inches and 5 feet. Specific types of hay include, but are not limited to alfalfa, timothy grass, orchard grass, clover and straw. The forage is cut in a field and dropped on to a discharge system. The discharge system loads the fresh cut forage into a transport vehicle as a loose mass as the forage is harvested. In an alternative embodiment, the fresh cut forage is formed into a narrow carpet prior to discharge into the transport vehicle.

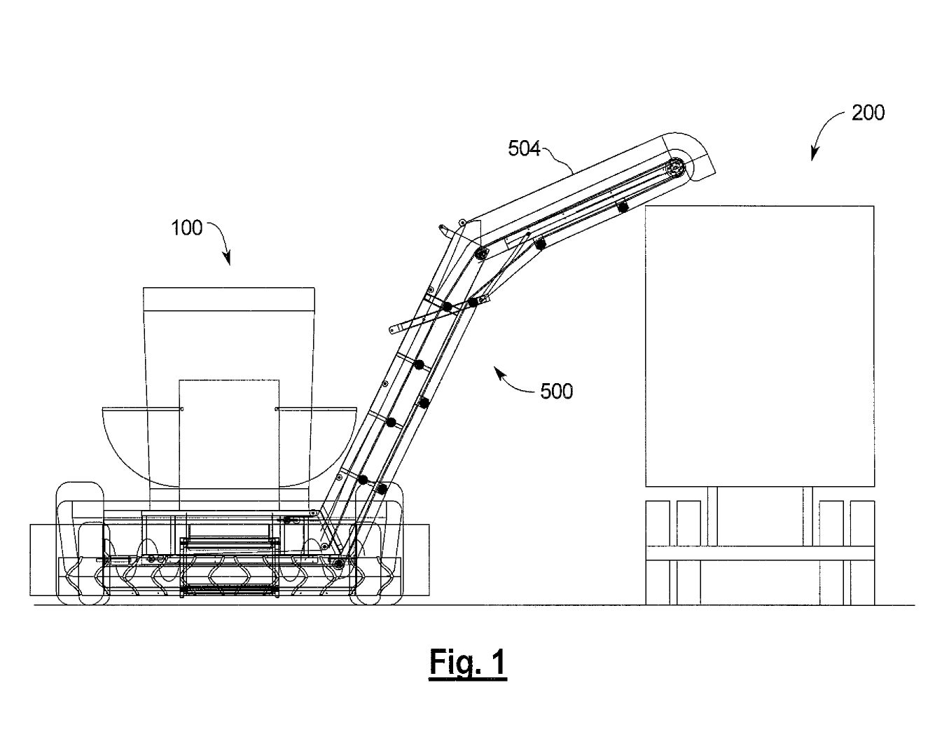

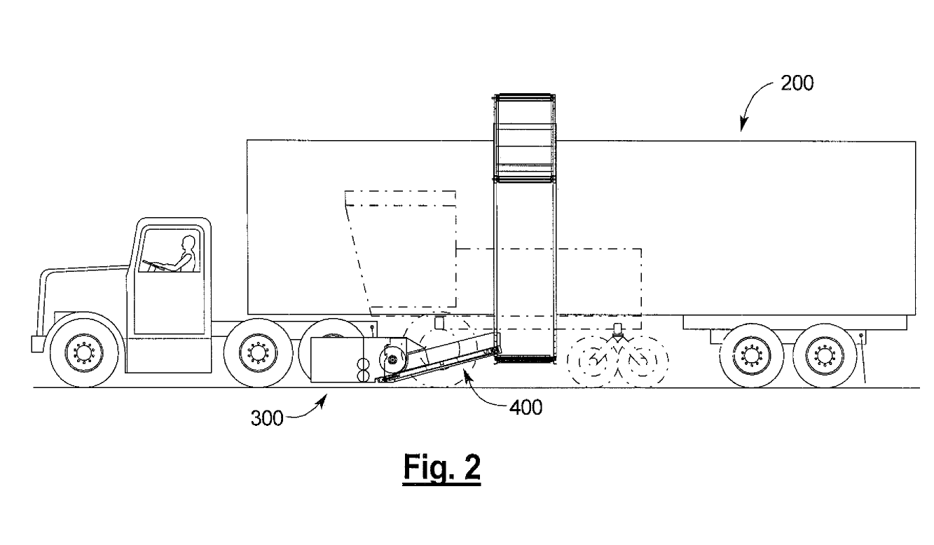

Referring to FIGS. 1 and 2, there is shown a harvester 100 and transport vehicle 200. The harvester 100 cuts forage from a field as the transport vehicle 200 drives along side the harvester 100 collecting the freshly cut forage that is discharged from a forage delivery platform 504. In an alternative embodiment the harvester 100 discharges the freshly cut forage from the rear and transport vehicle 200 drives behind the harvester 100. It is understood that although the transport vehicle 200 is shown as a trailer other transport vehicles capable of holding fresh cut forage in a loose mass can be used. For example, dump carts can collect the forage and transport the forage to a second transport vehicle such as a trailer or a trailer having a walking floor.

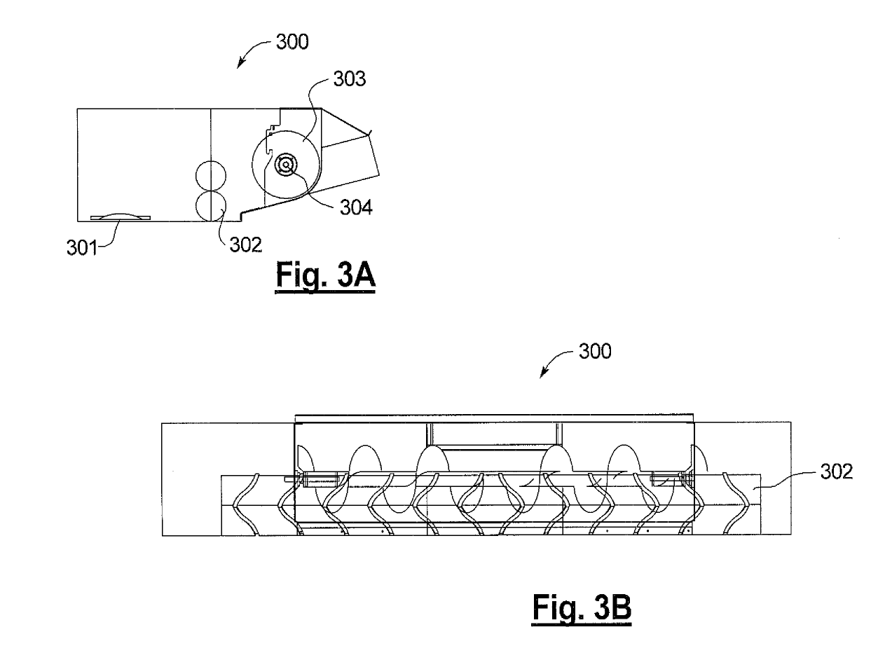

Referring to FIGS. 3A-3C there is shown the collector section 300 of the harvester 100. FIG. 3C is a front view of a collector section 300 with the cutting head 301 and crimping rolls 302 removed for clarity. The cutting head 301 cut the forage. The cutting head 301 can be any standard forage cutter, such as rotary head as shown in FIG. 3A or sickle cutters. In one embodiment the cutting head is between 12 and 14 feet wide. Once cut the crimping rolls 302 pull the forage between the crimping rolls 302. The crimping rolls 302 crush the stalks and remove some of the moisture from the forage. The crimping rolls 302 further guide the cut forage into the helical augers 303. An axel 304 rotates about its axis causing the helical augers 303 to rotate. The helical augers 303 guide the cut forage into a forage collection area 305. The helical augers 303 on the left side of the axel are threaded in the opposite direction from the helical augers on the right side of the axel 304 such that the cut forage is guided towards the center of the forage collection area 305. In one embodiment the forage collection area is about 3 feet wide. The forage travels through the forage collection area 305 and onto a planar discharge section 400.

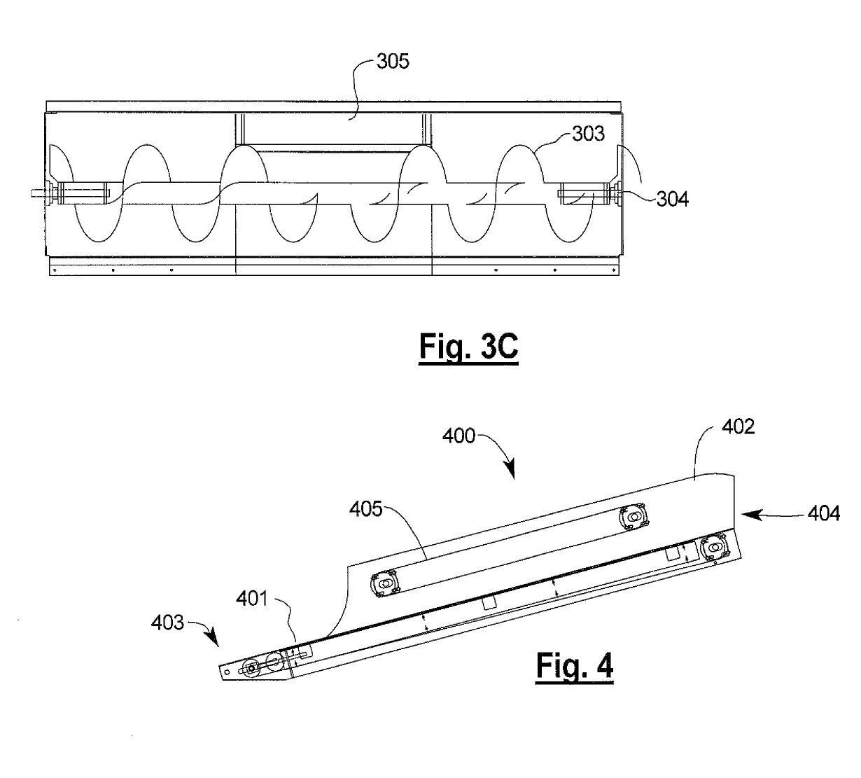

Referring to FIG. 4 there is shown a planar discharge section 400 of the harvester 100. The planar discharge section 400 receives the fresh cut forage from the collector section 300 at a receiving end 403. The forage is discharged from the forage collection area 305 (FIG. 3B) and dropped onto the receiving end 403 of the planar conveyor belt 401. The planar conveyor belt 401 transports the fresh cut forage, as a loose mass, in a substantially planar direction, to the discharge end 404. A conveyor belt 401 transports the forage, as a loose mass, from the discharge end 404 and onto a substantially vertical discharge section 500. In one embodiment the planar discharge section is about 40 inches wide and about 80 inches long. Retaining side walls 402 prevent any loose forage from falling off the sides of the conveyor belt 401. In one embodiment the retaining walls are about 10 inches high. In an additional embodiment the planar conveyor belt 401 and retaining walls 402 are narrower at the discharge end 404 than at the receiving end 403 to form a narrow carpet of forage.

In the embodiment shown in FIG. 4 a secondary planar conveyor belt 405 prevents clogging of forage. The lower surface of the secondary planar conveyor belt 405 moves in the same direction as the planar conveyor belt 401. The forage is sandwiched between the secondary planar conveyor belt 405 and the planar conveyor belt 401. With both the secondary planar conveyor belt 405 and the planar conveyor belt 401 exerting lateral force on the forage the possibility for clogging is significantly reduced.

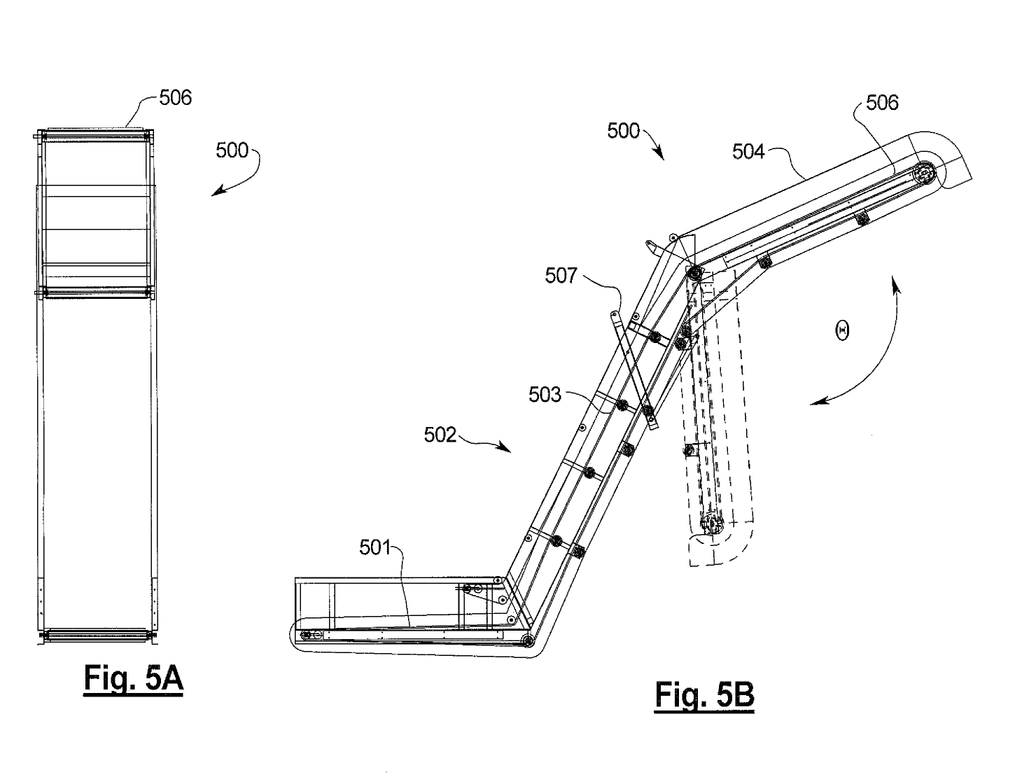

Referring to FIGS. 5A-5B there is shown a substantially vertical discharge section 500 of the harvester 100. The fresh cut forage is dropped from the discharge end 404 of the planer discharge section 400 into a collection belt 501. The collection belt 501 transports the forage to a vertical rise section 502. The vertical rise section 502 transfers the forage to an adjustable forage delivery platform 504. The vertical rise section 502 has an incline angle of about 65 degrees from the horizon in one embodiment. It is understood that the vertical rise section 502 can have varying angles. In one embodiment the vertical rise section 502 is enclosed or has side walls to prevent any loss of forage from the system. A substantially vertical conveyor belt 503 transports the forage from the collection conveyor belt 501 to the adjustable forage delivery platform 504.

The forage is dropped from the top of the substantially vertical conveyor belt 503 onto a forage delivery platform belt 506 in the adjustable forage delivery platform 504. In the embodiment shown in FIG. 5B, the collection conveyor belt 501, the substantially vertical conveyor belt 503 and a forage delivery platform belt 506 is a single belt wherein the angle of the belt changes through the various sections. The forage delivery platform 504 may have side walls or be fully enclosed to reduce or prevent loss of forage. The speed of the forage delivery platform belt 506 is adjustable to change the distance that loose forage is thrown. The height of the delivery platform 504 can range from about 6 to 17 feet above the ground. It is desirable to change the speed of the forage delivery platform belt 506 to adjust for varying environmental conditions such as wind. As shown in FIG. 5B the forage delivery platform 504 is adjustable through the angle θ from about 90 below the horizon to about 45 degrees above the horizon by moving an angle adjustment arm 507. In one embodiment the angle adjustment arm is a hydraulic arm capable of adjusting the angle of the delivery platform 504 relative to the horizon.

It should be noted that although the particular embodiment described above utilizes a conveyor system other forage transport systems can be utilized without departing from the scope of the invention. For example, a forced air system, rollers, tines, rakes, belts or chains can be used to transport the forage.

Forage is cut and transported as a loose mass to a transport vehicle without the forage ever lying on the ground to dry. By transporting the forage as a loose mass the need to bail the forage is eliminated.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

1. A forage harvesting device comprising:
a collector section having at least one cutter capable of cutting forage from a field; and
a substantially vertical discharge section containing a vertical rise section and a forage delivery platform.

2. The forage harvesting device of claim 1 wherein the forage delivery platform is at least 3 feet above the collector section.

3. The forage harvesting device of claim 1 wherein the forage delivery platform comprises a conveyor belt having adjustable speeds.

4. The forage harvesting device of claim 1 further comprising an angle adjustment arm to change the angle at which the forage delivery platform discharges forage.

5. The forage harvesting device of claim 1 further comprising a planer forage discharge section having a receiving end to collect the fresh cut forage from the forage collector and a discharge end for delivering the fresh cut forage to the substantially vertical forage discharge section as a loose mass.

6. The forage harvesting device of claim 5 where the planer forage discharge section collects the fresh cut forage from the forage collector and forms a carpet of forage, wherein the width of the carpet at the receiving end is less than the width of the carpet at the discharge end.

7. The forage harvesting device of claim 1 wherein the forage delivery platform discharges forage at a planar angle between about 15 to 165 degrees from the direction of cutting.

8. The forage harvesting device of claim 1 wherein the substantially vertical forage discharge section is a conveyor system.

9. The forage harvesting device of claim 8 wherein the conveyor system comprises conveyor belts about 3 feet wide.

10. The forage harvesting device of claim 5 wherein the collector section is at least 6 feet wide.

11. The forage harvesting device of claim 10 further comprising a forage carpet loader to collect the fresh cut forage from the cutter section and drop the fresh cut forage onto either the planer discharge section or the substantially vertical forage discharge section in a carpet having a width less that forage collector.

12. The forage harvesting device of claim 11 wherein the forage carpet loader drops the fresh cut forage onto either the planer discharge section or the substantially vertical forage discharge section in a carpet that is less than half the width of the forage collector.

13. The forage harvesting device of claim 1 wherein the forage is long strand forage.

14. The forage harvesting device of claim 13 wherein the long strand forage is selected from the group consisting of hay, grass, alfalfa and switchgrass.

15. A method for harvesting forage comprising:
cutting forage with a cutting section;
dropping fresh cut forage onto a forage discharge section;
transporting the fresh cut forage from a forage discharge section to a forage delivery platform;
discharging the fresh cut forage from the forage delivery platform and into a transport vehicle.

16. The method of claim 12 wherein the transport vehicle is a dump cart.

17. The method of claim 13 further comprising unloading the fresh cut forage from the dump cart into a trailer.

18. The method of claim 12 wherein the forage discharge section is a conveyor system.

19. The method of claim 12 wherein the forage delivery platform is at least 3 feet above the cutting section.

20. The method of claim 12 further wherein the forage transport system forms a forage carpet having a width that is less than the width of the cutting section.
